(19) United States
(12) Patent Application Publication
(10) Pub. No.: US 2004/0019478 A1
(43) Pub. Date: Jan. 29, 2004

(54) Interactive natural language query processing system and method

(75) Inventors: Brad L. Rucker, Allen, TX (US); Stephen T. Hoffmann, Plano, TX (US); Norman Tang, Plano, TX (US)

Correspondence Address: BAKER BOTTS L.L.P., 2001 ROSS AVENUE, SUITE 600, DALLAS, TX, 75201-2980, US

(73) Assignee: Electronic Data Systems Corporation

(21) Appl. No.: 10/208,111

(22) Filed: Jul. 29, 2002

(51) Int. Cl. G06F 17/28

(52) U.S. Cl. 704/5

(57) ABSTRACT

A method for interactive natural language query processing includes receiving a natural language query comprising a plurality of words. The received query is tokenized into individual words. The one or more tokenized words are then collapsed. An intersection of the collapsed words is then determined and one or more results are selected based at least in part on the intersection.

### TECHNICAL FIELD OF THE INVENTION

This invention relates to natural language systems and, more specifically, to an interactive natural language query processing system and method.

### BACKGROUND OF THE INVENTION

Currently, customizing presentations to target audiences desiring business offerings is tedious and requires a large effort. The content of the presentation is catered to each specific audience and event, therefore incurring a time penalty for each customization. Yet, the content of many presentations may vary little from venue to venue. Due to the frequency of presentations and the current difficulty in addressing each audience uniquely, current presentations offer limited flexibility in delivering targeted content.

### SUMMARY OF THE INVENTION

One aspect of the invention is a method for interactive natural language query processing including receiving a natural language query comprising a plurality of words. The received query is tokenized into individual words. The one or more tokenized words are then collapsed. An intersection of the collapsed words is then determined and one or more results are selected based at least in part on the intersection.

The invention has several important technical advantages. Various embodiments of the invention may have none, some or all of these advantages. This invention may allow sales teams to focus the content of each presentation to a specific audience. It may also induce the target audience to ask questions about various business offerings and allow a salesperson to properly answer using an interactive multimedia presentation. A further advantage may be that the invention can retrieve targeted website frames and sort them according to a query entered by a site visitor. Similarly, content can be automatically weighted, prioritized and delivered to an audience based on historical use statistics. Other technical advantages of the present invention will be readily apparent to one skilled in the art.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates a computer system for interactive natural language query processing in accordance with one embodiment of the present invention;

FIG. 2 illustrates collapsing a verb in accordance with the computer system of FIG. 1;

FIG. 3 illustrates a noun-verb matrix in accordance with the computer system of FIG. 1;

FIG. 4 illustrates an object table in accordance with the computer system of FIG. 1;

FIG. 5 illustrates a business offerings table in accordance with the computer system of FIG. 1;

FIG. 6 illustrates a presentation table in accordance with the computer system of FIG. 1;

FIG. 7 illustrates one example of sorting the results in accordance with the computer system of FIG. 1; and

FIG. 8 is a flow diagram illustrating a method for interactive natural language query processing in accordance with one embodiment of the present invention.

### DETAILED DESCRIPTION OF EXAMPLE EMBODIMENTS OF THE INVENTION

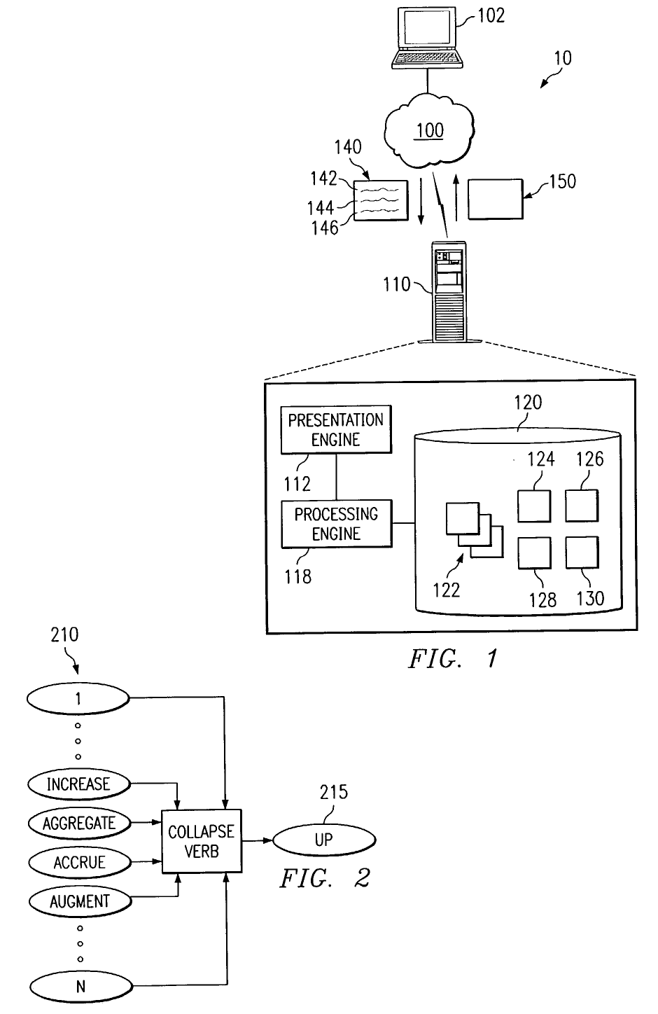

FIG. 1 illustrates a computer system 10 for interactive natural language query processing in accordance with one embodiment of the present invention. System 10 includes network 100, one or more clients 102, and one or more servers 110. Other embodiments of system 10 may be used without departing from the scope of this disclosure. In general, the present invention may process verbally expressed business problems—input as a natural language query 140—and present one or more appropriate technology and/or business solutions—or results 150.

Network 100 is coupled to one or more servers 110 and one or more clients 102. Network 100 facilitates wireless or wireline communication between components of system 10. Network 100 may, for example, communicate Internet Protocol (IP) packets, Frame Relay frames, Asynchronous Transfer Mode (ATM) cells, voice, video, data, and other suitable information between network addresses. Network 100 may include one or more local area networks (LANs), radio access networks (RANs), metropolitan area networks (MANs), wide area networks (WANs), all or a portion of the global computer network known as the Internet, and/or any other communication system or systems at one or more locations.

Client computer system 102 may include appropriate input devices, output devices, mass storage media, processors, memory, or other components for receiving, processing, storing, and/or communicating information. As used in this document, the term “computer” is intended to encompass a personal computer, workstation, network computer, kiosk, wireless data port, datashow, wireless telephone, personal digital assistant (PDA) , one or more processors within these or other devices, or any other suitable processing device. It will be understood that there may be any number of clients 102 coupled to network 100.

Server 110 comprises an electronic computing device operable to receive, transmit, process and store data associated with system 10. For example, server 110 may comprise a general-purpose personal computer (PC), a Macintosh, a workstation, a UNIX-based computer, a server computer, wireless data port, datashow, wireless telephone, personal digital assistant (PDA), or any other suitable device. Server 110 may be operable to communicate with client computers 102. For example, server 110 may communicate with client computers 102 over the network 100 (in real-time, batch, or a combination thereof). Or, in the alternative, it will be understood that client computer 102 and server 110 may illustrate different modules included in the same computing device.

Server 110 may also be a web server. One function of web server 110 (or a pool of servers) might be to allow a client 102 to send or receive content over or from the Internet using a standard user interface language such as, for example, the Extended Markup Language (XML) or Hypertext Markup Language (HTML). Server 110 can accept an input query 140 from client 102 via a web browser (e.g., Microsoft Internet Explorer or Netscape Navigator) and return the appropriate HTML documents that may include data from one or more database tables 122-128.

Server 110 includes presentation engine 112, processing engine 118, and memory 120. Presentation engine 112 may be any module that can process the results 150 to be communicated in response to the query 140. Presentation engine 112 may select one or more slide presentations, select one or more websites for presentation, merge multiple results 150 into one result 150, or process the merged result 150 to ensure that there is no duplicate data. Presentation engine 112 may also assign a weighting criteria to multiple results 150, sort the multiple results 150, and select one result 150 based, at least in part, on the weighting criteria. In this document, the result 150 may be any data that is communicated in response to a natural language query 140 including a multimedia presentation, white papers, web pages, business plans, financial documents, and others.

Processing engine 118 may receive the input query 140 from and communicate the result 150 to client 102, the presentation engine 112, memory 120, or other suitable modules or devices. Processing engine 118 processes the natural language query 140 to generate results 150. Processing the query 140 may include tokenizing the query 140 into individual words, collapsing one or more tokenized words, determining the category of a tokenized word, combining the words into an intersection, or any other appropriate processing as described in greater detail below. It will be understood that while presentation engine 112 and processing engine 118 are illustrated as separate modules, the features and functionality performed by these engines may be performed by a common module or grouped to multi-tasked modules.

Memory 120 may include any memory or database module and may take the form of volatile or non-volatile memory including, without limitation, magnetic media, optical media, random access memory (RAM), read-only memory (ROM), removable media, or any other suitable local or memory component. Further, the tables may be of any suitable format including XML tables, flat files, comma-separated-value (CSV) files, SQL tables, relational database tables, and others. In this embodiment, memory 120 includes collapse tables 122, noun-verb matrix 124, object table 126, business offerings table 128, and presentation table 130.

In one aspect of operation, client 102 may submit a natural language input query 140 for processing by system 10. As used herein, a natural language query 140 may include nouns 142, verbs 144, and objects 146. A noun 142 or a verb 144 is a word that is be collapsed or generalized into a generic noun or verb, respectfully. An object 146 may be a word that is defined by system 10 as a specific reference to a business or information technology area. In some embodiments, object 146 may also be collapsed into a collapsed object. For example, the natural language query 140 may be “How do I lower cost in my shipping department?” The query 140 is communicated to server 110 through network 100. Server 110 receives the query 140 into processing engine 118.

Processing engine 118 processes the query 140 and may utilize none, one, or many of the database tables 122-128. Processing engine 118 tokenizes the query 140 into individual words. In the example, the result of the tokenizing would be “How”, “do”, “I”, “lower”, “cost”, “in”, “my”, “shipping”, and “department”. The processing engine 118 then determines the category (such as noun, verb, or object) of each tokenized word. It should be understood that a word may not belong to a category and, therefore, may not be further processed. Returning to the example, “lower” is categorized as a verb 144, “cost” is categorized as a noun 142, and “shipping” is categorized as an object 146.

Processing engine 118 then collapses the one or more categorized words using the appropriate collapse table 122. For example, each tokenized word is replaced by a collapsed word retrieved from collapse table 122. The collapsed word may be considered as a generalized word relating to the tokenized word. Further, the tokenized word may collapse into different collapsed words based on the category the tokenized word is assigned. It should be noted that the collapsed word and the tokenized word may be the same. Using the example, the verb 144 “lower” may be collapsed to “down” and the noun 142 “cost” collapsed to “cost”. As illustrated in FIG. 2, there may be a plurality of tokenized words that are collapsed into the same collapsed word.

FIG. 2 illustrates one embodiment of collapsing a verb in accordance with system 10 of FIG. 1. While FIG. 2 illustrates collapsing a tokenized word assigned the verb 144 category, it will be understood that similar processing may occur for nouns 142, objects 146, or any other category. FIG. 2 includes input tokenized word 210, which illustrates the 1:n possibilities of words that may be run through the collapse processing. As multiple natural language queries may call for the same or similar results, collapsing a query to a more generalized form allows system 10 to efficiently process similar queries to obtain the relevant business or technology solutions.

Input tokenized word 210 is collapsed into a collapsed word 215, based at least in part, on the verb 144 category. In a first example, the input query 140 contains the word “aggregate.” In this example, system 10 collapses “aggregate” into result 215 “up.” In a second example, the input 210 may be “increase.” Again, the collapsed word 215 may be “up” as shown in FIG. 2. It will be understood that FIG. 2 is for exemplary purposes only. It will be further understood that the input tokenized word 210 may collapse into none, one, or many collapsed words 215. Also, as described in more detail above, it is possible that some words in the input query 140 are not collapsed. Once the collapsed word 215 is selected, system 10 may replace the tokenized word 210 with the collapsed word 215.

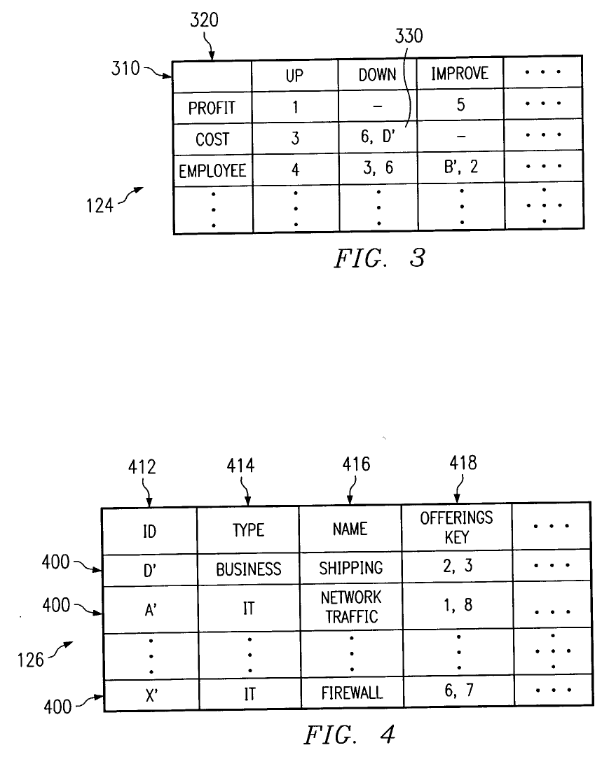

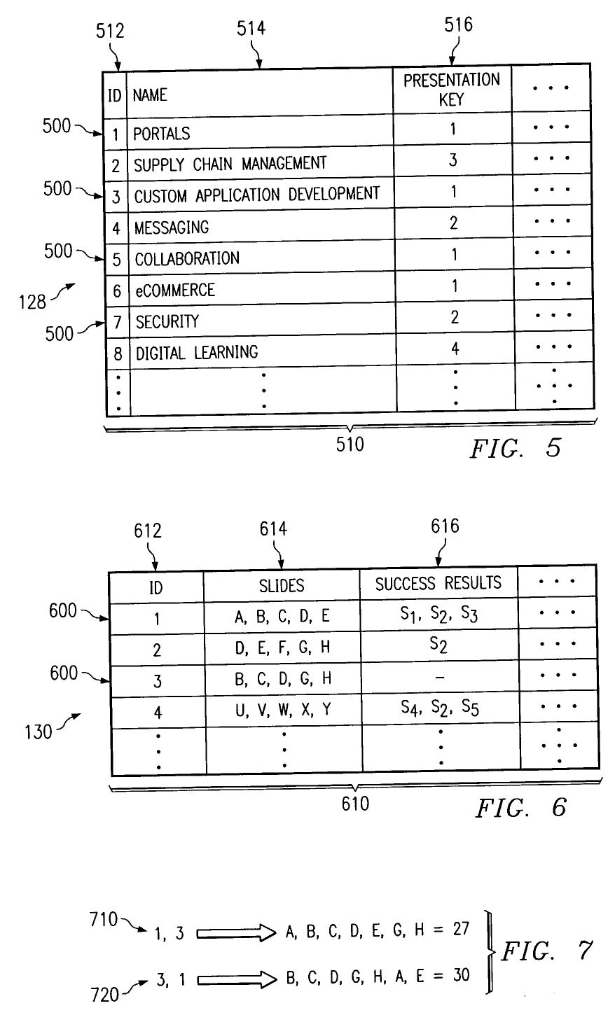

Returning to FIG. 1, after the appropriate tokenized words are collapsed, processing engine 118 combines the collapsed nouns 142, collapsed verbs 144, and objects 146 into an intersection—shown in more detail in noun-verb matrix 124 of FIG. 3. The intersection of nouns 142, verbs 144, and/or objects 146 allows server 110 to perform a more robust contextual search for results 150. If the query 140 contained an object word, then processing engine 118 locates the intersection in a noun-verb-object matrix. It will be understood that, for exemplary purposes, the noun-verb-object matrix is illustrated by noun-verb matrix 124 and object table 126, shown in more detail in FIG. 4. If the query 140 does not contain an object, the processing engine 118 locates the intersection in noun-verb matrix 124. In one embodiment, an intersection from noun-verb matrix 124 comprises a link to one or more business offerings from the business offerings table 128, shown in more detail in FIG. 5, to the intersection. The intersection and linked business offerings may be generally referred to as an intersection.

After the query 140 is properly tokenized into individual words, collapsed, and combined into an intersection, the processing engine 118 communicates the selected intersection to presentation engine 112. Presentation engine 112 receives the processed query 140 and selects one or more results 150 based, at least in part, on the intersection. Presentation engine 112 may access presentation table 130 to retrieve one or more results 150. As described in more detail in FIG. 6, each result 150 may include multiple slides, web pages, documents, success stories, or any other data that appropriately responds to the input query 140. Presentation engine 112 may merge multiple results 150 into a merged result 150, process the merged result 150 to ensure that there is no duplicate data, assign a weighting criteria to multiple results 150, sort the multiple results 150, and/or select one result 150 based, at least in part, on the weighting criteria.

Once the result 150 is determined by server 110, the result 150 is communicated to client 102 through network 100. It will be understood that result 150 may include any data including a failure to find suitable results. In an alternative embodiment, a first client 102 submits the input query 140 for processing by system 10. After processing the query 140, server 110 communicates the result 150 to a second client 102. In other words, the client 102 submitting the query 140 and the client 102 receiving result 150 may be the same or different computers.

FIG. 3 illustrates one embodiment of a noun-verb matrix 124 in accordance with system 10. In general, processing engine 118 uses noun-verb matrix 124 to conjoin at least one collapsed noun 142 and at least one collapsed verb 146 from the query 140. Therefore, noun-verb matrix 124 is a multi-dimensional data structure that includes at least one noun-verb intersection 330. Each intersection 330 is a cell that is defined by a noun category 320 and a verb category 310. Each intersection 330 may include none, one, or many links to other data. For example, the link may be a key to a record in the object table 126, a pointer to a presentation record 600 in presentation table 130, or a link to a business offering record 500 in business offerings table 128. This allows noun-verb matrix 124 to provide a convergence of similar business concepts. Therefore, system 10 can use several related collapsed words to locate results 150 within a business context.

The example verb 310 categories shown in noun-verb matrix 124 are “up”, “down”, and “improve”. The example noun 320 categories shown in noun-verb matrix 124 are “profit”, “cost”, and “employee”. In one example, the collapsed words may be “up” and “profit”. In this example, the intersection 330 is “1”, which points to a presentation record 600 in presentation table 130 (described in more detail in FIG. 6). The verb and noun categories 310 and 320 illustrated in noun-verb matrix 124 are merely exemplary. System 10 contemplates any other suitable category to allow for suitable collapsing of tokenized words from the input query 140. Moreover, noun-verb intersections 330 may be multi-dimensional. In one embodiment, noun-verb matrix 124 contemplates a third axis—object. In this embodiment, system 10 may conjoin one collapsed noun 142 and one collapsed verb 143 from the query 140 to locate a plurality of noun-verb intersections 330 extending along the object axis. In other words, if there is a third axis, the intersection 330 may comprise a plurality of cells, each cell corresponding to a different object for the same noun-verb combination.

Returning to the exemplary query 140 from FIG. 1, system 10 uses the collapsed words “down” and “cost” resulting in the intersection 330 being “6, D′”. In this example, the intersection 330 includes a business offerings ID 511 (“6”) and an object ID 412 (“D′”). The business offerings ID 511 comprises a link to business offerings table 128 (described in FIG. 5) and the object ID 412 comprises a link to the object table 126 (described in FIG. 4).

FIG. 4 illustrates one embodiment of the object table 126 in accordance with the system 10. In general, system 10 may use object table 126 to store and process objects from the query 140. Object table 126 is a multidimensional data structure that includes at least one object record 400. Each object record 400 includes multiple columns 410. In this example, object record 400 includes an object ID 412, an object type 414, an object name 416, and a business offerings key 418. It will be understood that each object record 400 may include none, some, or all of the example columns 410. In one embodiment, object record 400 may include a link to another table, such as, for example, business offerings key 418 may be used to access particular entries of business offerings table 128. It should be noted that the object record 400 may be accessed by object ID 412, object name 416, or any other field.

The example object records 400 shown in object table 126 are “Shipping”, “Network Traffic”, and “Firewall”. The object records 400 illustrated in object table 126 are merely exemplary. System 10 contemplates any other suitable object to allow for suitable processing of an input query 140. Moreover, object table 126 may be separated into multiple tables without departing from the scope of the invention. In one embodiment, object table 126 is represented by two data structures: a business objects data structure and an IT objects data structure. In an alternative embodiment, object table 126 and noun-verb matrix 124 are combined into a noun-verb-object matrix (not shown).

Returning to the exemplary query 140 from FIG. 1, the query 140 included the business area, or object 146, “shipping.” System 10 may access object table 126 to locate the appropriate object record 400. In this example, system 10 would use the tokenized word “shipping” to find the object record 400 with the object name 416 of “shipping”. System 10 may then use the appropriate business offerings keys 418 to locate one or more records in the business offerings table 128. Further, system 10 will use the object ID 412 of “D′”, from the example processing illustrated in FIG. 3, to locate the “Shipping” record 400. Object table 126 provides system 10 a business or technical supplement to noun-verb matrix 124. Using the example, “shipping” allows system 10 to focus the results from the intersection 330 of “down” and “cost”. In this example, the results may specifically pertain to reducing costs in a shipping context.

FIG. 5 illustrates one embodiment of the business offerings table 128 in accordance with the computer system 10. Business offerings table 128 is a multi-dimensional data structure that includes at least one business offering record 500. Each business offering record 500 includes multiple columns 510. In this example, business offering record 500 includes a business offering ID 512, a business offering name 514, and a presentation key 516. Presentation key 516 may comprise a link to a presentation record 600 in presentation table 130. It will be understood that each business offering record 500 may include none, some, or all of the example columns 510. One technical advantage of business offerings table 128 is that it allows system 10 to efficiently link the conjoined business concepts to the business offerings that provide various business or technology solutions.

The example business offerings shown in business offerings table 128 are “Portals”, “Supply Chain Management”, “Custom Application Development”, “Messaging”, “Collaboration”, “eCommerce”, “Security”, and “Digital Learning”. The business offerings illustrated in business offerings table 128 are merely exemplary. System 10 contemplates any other suitable business offering that allows for selecting a suitable result 150 in response to the input query 140.

Returning to the exemplary query 140 from FIG. 1, the object record 400, with the object ID 412 of “D′” was located using the tokenized object 146 “shipping” (as illustrated in FIG. 4). The object record 400 included two links to the business offerings table 128, “2” and “3”. System 10 may then access the business offering record 500 using the links as business offering IDs 412. System 10 uses these business offering records 500 to locate the appropriate presentation links 516, “3” and “1”. These presentation links 516 may be used to locate presentation records 600 in presentation table 130. Further, system 10 will use the business offering ID “6”, from the example processing illustrated in FIG. 3, to access the “eCommerce” record for processing similar to above. Additionally, system 10 uses the object ID 411 “D′”, again from the example processing illustrated in FIG. 3, to access the “Supply Chain Management” and “Custom Application Development” records for processing similar to above. Once the appropriate business offering records 500 are accessed, system 10 may then access presentation table 130 to compile the appropriate results 150.

FIG. 6 illustrates one embodiment of presentation table 130. Presentation table 130 is a multi-dimensional data structure that includes at least one presentation record 600. Each presentation record 600 includes multiple columns 610. In this example, presentation record 600 includes a presentation ID 612, a slides column 614, and success stories 616. It will be understood that each presentation record 600 may include none, some, or all of the example columns 610. Further, while slides column 614 is described with reference to example digital slides, it will be understood that presentation table 130 may include white papers, web pages, business plans, financial documents, and any other business or technology solution that may be communicated as answer 150 in response to a natural language query 140. Thus, presentation engine 112 provides system 10 with numerous results that can be quickly customized in response to various input queries 140.

The example presentations shown in presentation table 130 are slideshows 1-4. Each slideshow includes a plurality of digital slides, represented here by A, B, C, etc. Each slideshow may also include one or more success stories, illustrated here in column 613. The presentations illustrated in presentation table 130 are merely exemplary. System 10 contemplates any other suitable presentation that may be communicated in response to a natural language query 140.

Returning to the exemplary query 140 from FIG. 1, the presentation records 600 “1” and “3”, associated with the business offering records 500 of “Supply Chain Management”, “Custom Application Development” and “eCommerce”, are processed by system 10. Each presentation record 600 may contain unique slides that are specific to a particular business offering or general slides that may be common to other presentation records 600. For example, presentation record 600 “1” includes slides “A”, “B”, “C”, “D”, and “E”. Example presentation record 600 “3” includes slides “B”, “C”, “D”, “G”, and “H”. Each example presentation record 600 includes common slides “B”, “C”, and “D”. These common slides may represent a common business or technology solution incorporated by the linked business offerings 500 “Supply Chain Management”, “Custom Application Development”, and “eCommerce”. Further, in the example, presentation record 600 “3” was selected by business offering record 500 “Supply Chain Management”. Therefore, exemplary unique slide “G” may be tailored to a query 140 involving supply chain management. In this regard, presentation engine 112 is able to identify appropriate slides, or other suitable results 150, based upon query 140, intersection 330, and business offering records 500 in order to provide client 102 with customized and targeted information.

If server 110 merges the two presentations into a single presentation, the resulting merged presentation will include unique slides “B”, “C”, and “D” and not duplicate them. The merged presentation may include the merging presentations in any order as illustrated in more detail by FIG. 7.

FIG. 7 illustrates an example of sorting the results 150 in accordance with one embodiment of system 10. In this example, slideshow presentation records “1” and “3” from FIG. 6 are used. It will be understood that any other suitable records including any suitable data may be assigned a weight and sorted as described in FIG. 7 without departing from the scope of this disclosure. Further, FIG. 7 may illustrate the results 150 of various processing steps or the results 150 taken from an additional table in memory 120 containing weighting criteria for various results 150. Therefore, the weighting criteria may be an assigned value that is stored in memory 120 or a value assigned by an automatic processing step using any logic. As used herein, weighting criteria means any numerical value, logical weight, or any other criteria operable to rank the results 150.

FIG. 7 includes two possible results 150, solution 710 and solution 720, of merging presentations “1” and “3”. It will be understood that solutions 710 and 720 illustrate different combinations of results 150. Solution 710 presents the slides from presentation “3” after presentation “1”. Solution 720 presents the slides from presentation “1” after presentation “3”. Both solutions 710 and 720 have a weighting criteria assigned to them. As mentioned above, this weighting criteria may be computed or stored in a table in memory 120. The weighting criteria may change and may also differ based on the input query 140. In other words, a first query 40 may assign solution 720 a weighting criteria of “30” and solution 710 a weighting criteria of “27”. But an alternative query 140 may assign solution 720 a weighting criteria of “21” (not shown) and solution 710 a weighting criteria of “25” (not shown).

As described above, the weighting of results 150 can be the outcome of any number of processes including automatic processing, sorting based on the user that input the query 140, a hard-coded value assigned to particular results 150, and others. For example, system 10 may process a query 140 containing an Information Technology (IT) word (e.g. internet or email) and subsequently rank the IT results higher than non-IT results. In another example, the query 140 may be input by a security professional. System 10 might then rank the result 150 containing a security business offering higher than others. In a further example, a network salesman may hard-code system 10 to always present an eCommerce portion of a presentation before any other portions, regardless of the query 140. He then has the ability to present a standard opening, while customizing a later portion of the presentation for a particular client.

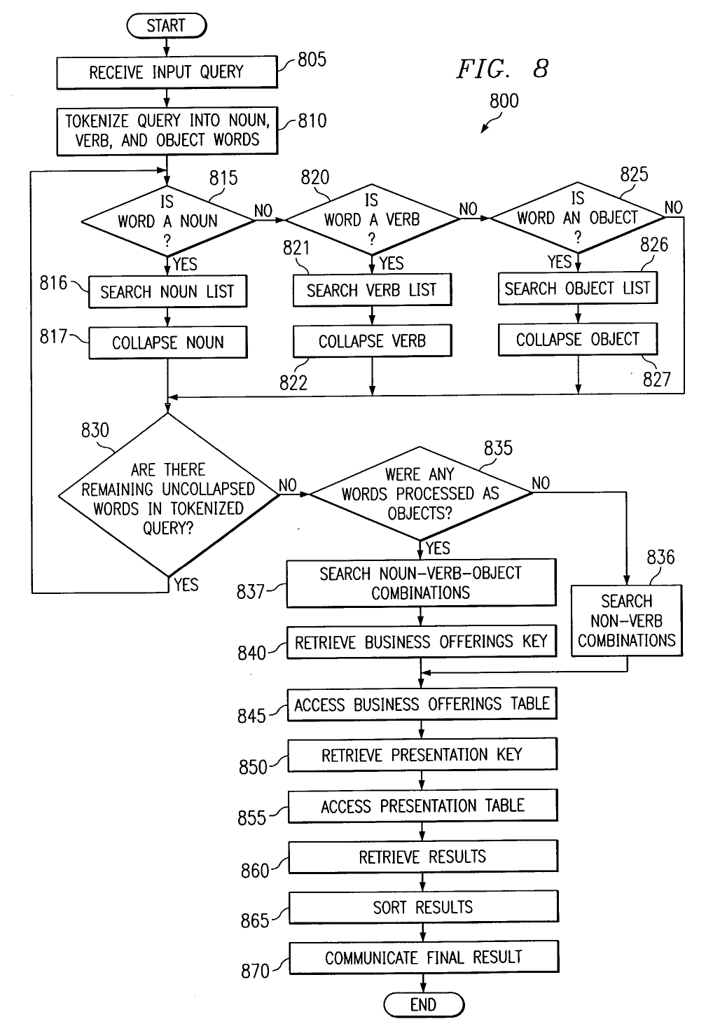

FIG. 8 is a flow diagram illustrating a method 800 for interactive natural language query 140 processing in accordance with one embodiment of the present invention. Method 800 may be described with respect to system 10 of FIG. 1. Any other suitable system may use method 800 to process an interactive natural language query 140 without departing from the scope of this disclosure.

An input query 140 from client 102 is received at server 110 in step 805. As described above, the input query 140 may be a website query 140, a question from a customer's PDA, or any other natural language inquiry. It will be understood that the query 140 will include one or more words. Once received, processing engine 118 tokenizes query 140 into nouns 142, verbs 144, and object 146 words at step 810. Generally, tokenizing includes breaking the input query 140 into individual words. However, tokenizing may further include sorting the words or any other processing suitable for this invention. Execution proceeds to steps 815-825 where the categories of the individual words are determined.

At decisional step 815, processing engine 118 begins processing the tokenized sentence at the first word. It first determines whether the tokenized word is a noun 142. At step 815, if processing engine 118 determines the word to be a noun 142, execution proceeds to step 816. At step 816, processing engine 118 searches a noun list or noun collapse table 122. Execution proceeds to step 817, where processing engine 118 collapses the noun 142 based upon the noun list or collapse table 122. Execution proceeds to a decisional step 830. Processing engine determines if there are remaining uncollapsed words in the tokenized query 140. If uncollapsed words are found, execution returns to step 815. Otherwise, execution proceeds to step 835.

If processing engine 118 determines that the word is not a noun 142 as determined at step 815, execution proceeds to step 820. At step 820, if the processing engine 118 determines that the word is a verb 144, execution proceeds to step 821. At step 821, processing engine searches a verb list or verb collapse table 122. Next, at step 822, processing engine collapses the verb 144 based upon the verb list or collapse table 122. Execution then proceeds to decisional step 830. If processing engine 118 determines there are remaining uncollapsed words in the tokenized query 140, execution returns to step 815. Otherwise, execution proceeds to step 835.

If processing engine 118 determines that the word is not a noun 142 or a verb 144 as determined at steps 815 and 820, then execution proceeds to step 825 where processing engine 118 determines whether the tokenized word is an object 146. If the word is determined to not be an object 146, processing engine 118 does not process the word and execution proceeds to step 830. However, if processing engine 118 determines that the word is an object 146, execution proceeds to step 826 where presentation engine 112 accesses object table 126. Then, at step 827, presentation engine 112 collapses the object 146 based on the object table 126.

At decisional step 830, if there are no remaining uncollapsed words in the tokenized query 140, execution proceeds to decisional step 835. If processing engine 118 processes any of the words as objects at step 826 and 827, then execution proceeds to step 837. Otherwise, execution proceeds to step 836 where processing engine 118 searches noun-verb combinations using the noun-verb matrix 124. At step 837, processing engine 118 searches noun-verb-object combinations. As described earlier, the noun-verb-object combinations may be in one or more tables. For example, processing engine 118 may utilize the noun-verb matrix 124 and the object table 126 or may use a three dimensional noun-verb-object matrix (not shown).

Next, at step 840, if there is an object 146 in the query 140, then processing engine 118 retrieves the business offering key 518 from object table 126. Processing engine 118 accesses business offering table 128, at step 845, using the business offering key 518 from object table 126 or a link from noun-verb matrix 124. Processing engine 118 retrieves presentation key 516 from business offering table 128 at step 850 as communicates this value to presentation engine 112. Execution proceeds to step 855, where presentation engine 112 accesses presentation table 130 using the one or more presentation keys 616. Presentation engine 112 retrieves the results 150 from presentation table 130 at step 860.

At step 865, presentation engine 112 sorts and ranks the results 150 to determine the more appropriate result 150 in response to the query 140. In one embodiment of the present invention, presentation engine applies a weighting criteria to each result 150. Presentation engine then selects a result 150 based on the weighting criteria. Once presentation engine 112 sorts, ranks, and selects the final result 150, server 110 communicates the final result 150 to client 102 at step 870. It will be understood that the final result 150 may include any suitable data, including a wide variety of multimedia presentations, documents, and others.

Although FIG. 8 illustrates one example of a method 800 of interactive natural language query 140 processing, various changes may be made to method 800 without departing from the scope of this disclosure. Also, while FIG. 8 illustrates five decisional steps 815, 820, 825, 830, and 835, other and/or additional decisional steps may be used in method 800. Further, the order of decisional steps 815, 820, 825, 830, and 835 is for illustration only.

Although the present invention has been described in detail, it should be understood that various changes, substitutions and alterations can be made hereto without departing from the sphere and scope of the invention as defined by the appended claims.

To aid the Patent Office, and any readers of any patent issued on this application in interpreting the claims appended hereto, applicants wish to note that they do not intend any of the appended claims to invoke ¶6 of 35 U.S.C. § 112 as it exists on the date of filing hereof unless “means for” or “step for” are used in the particular claim.

What is claimed is:

1. A method for interactive natural language query processing comprising:
receiving a natural language query comprising a plurality of words;
tokenizing the received query into individual words;
collapsing one or more tokenized words;
determining an intersection of the collapsed words; and
selecting one or more results based at least in part on the intersection.

2. The method of claim 1, wherein the tokenized words comprise at least one tokenized noun and at least one tokenized verb.

3. The method of claim 2, wherein the tokenized words further comprise at least one tokenized object.

4. The method of claim 3, wherein the tokenized object comprises a link to one or more business offerings.

5. The method of claim 1, wherein the intersection comprises a link to one or more objects.

6. The method of claim 2, wherein determining an intersection based on the collapsed words comprises determining an intersection based at least in part on the collapsed nouns and verbs, wherein the intersection comprises a link to one or more business offerings.

7. The method of claim 6, wherein selecting one or more results based at least in part on the intersection comprises:
selecting one or more presentation keys based at least in part on the linked business offerings; and
selecting one or more results based on the presentation keys.

8. The method of claim 1, wherein each result comprises a digital slide presentation.

9. The method of claim 8, further comprising merging two or more digital slide presentations, wherein at least two digital slide presentations comprise a common slide and the merged digital slide presentation comprises unique slides.

10. The method of claim 1, further comprising:
assigning a weighting criteria to each selected result; and
selecting one result based on the weighting criteria.

11. The method of claim 1, wherein collapsing one or more tokenized words comprises:
determining the category of the tokenized word;
selecting a collapsed word based at least in part on the category; and
replacing the tokenized word with the collapsed word.

12. The method of claim 11, wherein the tokenized word and the collapsed word are identical.

13. A system for interactive natural language query processing comprising:
logic encoded in one or more media; and
the logic is operable when executed to receive a natural language query, wherein the query comprises two or more words, to tokenize the received query into individual words, to collapse one or more tokenized words, to determine an intersection based on the collapsed words, and to select one or more results based at least in part on the intersection.

14. The system of claim 13, wherein the tokenized words comprise at least one tokenized noun and at least one tokenized verb.

15. The system of claim 14, wherein the tokenized words further comprise at least one tokenized object.

16. The method of claim 15, wherein the tokenized object comprises a link to one or more business offerings.

17. The system of claim 13, wherein the intersection comprises a link to one or more objects.

18. The system of claim 14, wherein the logic is further operable to determine an intersection based at least in part on the collapsed nouns and verbs, wherein the intersection comprises a link to one or more business offerings.

19. The system of claim 18, wherein the logic is further operable to select one or more presentation keys based, at least in part, on the linked business offerings, and select one or more results based on the presentation keys.

20. The system of claim 13, wherein each result comprises a digital slide presentation.

21. The system of claim 20, wherein the logic is further operable to merge two or more digital slide presentations, wherein at least two digital slide presentations comprise a common slide and the merged digital slide presentation comprises unique slides.

22. The system of claim 13, wherein the logic is further operable to assign a weighting criteria to each selected result and to select one result based on the weighting criteria.

23. The system of claim 13, wherein the logic is further operable to determine the category of the tokenized word, select a collapsed word based at least in part on the category, and replace the tokenized word with the collapsed word.

24. The system of claim 23, wherein the tokenized word and the collapsed word are identical.

25. A system for interactive natural language query processing comprising:
memory operable to store at least one result and at least one collapse record; and
a processor operable to receive a natural language query, wherein the query comprises two or more words, to tokenize the received query into individual words, to collapse one or more tokenized words based on at least one collapse record, to determine an intersection based on the collapsed words, and to select one or more results based at least in part on the intersection.

26. The system of claim 25, wherein the tokenized words comprise at least one tokenized noun and at least one tokenized verb.

27. The system of claim 26, wherein the tokenized words further comprise at least one tokenized object.

28. The method of claim 27, wherein memory is further operable to store at least one business offering and the tokenized object comprises a link to one or more business offerings.

29. The system of claim 26, wherein the intersection comprises a link to one or more objects.

30. The system of claim 26, wherein the processor is further operable to determine an intersection based at least in part on the collapsed nouns and verbs, wherein the intersection comprises a link to one or more business offerings.

31. The system of claim 30, wherein the processor is further operable to select one or more presentation keys based, at least in part, on the linked business offerings, and select one or more results based on the presentation keys.

32. The system of claim 25, wherein each result comprises a digital slide presentation.

33. The system of claim 32, wherein the processor is further operable to merge two or more digital slide presentations, wherein at least two digital slide presentations comprise a common slide and the merged digital slide presentation comprises unique slides.

34. The system of claim 25, wherein the processor is further operable to assign a weighting criteria to each selected result and to select one result based on the weighting criteria.

35. The system of claim 25, wherein the processor is further operable to determine the category of the tokenized word, select a collapsed word record based at least in part on the category, and replace the tokenized word with the collapsed word based on the collapse record.

36. The system of claim 35, wherein the tokenized word and the collapsed word are identical.
